(19) United States
(12) Patent Application Publication
(10) Pub. No.: US 2023/0281060 A1
(43) Pub. Date: Sep. 7, 2023

(54) DISTRIBUTED, DETERMINISTIC COMPUTE AND NETWORKING CO-SCHEDULING SYSTEM FOR CYBER-PHYSICAL SYSTEMS BASED ON A TIME-TRIGGERED ARCHITECTURE

(71) Applicants: Flavio Bonomi, Palo Alto, CA (US); John B. Vicente, Roseville, CA (US)

(72) Inventors: Flavio Bonomi, Palo Alto, CA (US); John B. Vicente, Roseville, CA (US)

(21) Appl. No.: 18/178,876

(22) Filed: Mar. 6, 2023

Related U.S. Application Data
(60) Provisional application No. 63/372,345, filed on Mar. 5, 2022.

(51) Int. Cl. G06F 9/50; G06F 9/48

(52) U.S. Cl. CPC G06F 9/5077; G06F 9/4881

(57) ABSTRACT

The technology described herein includes receiving a global demand to process a workflow; determining if one or more virtual resources are available to process the workflow; in response to the one or more virtual resources being available to process the workflow, determining if the one or more virtual resources have available timeslots for a class of service of the workflow; and in response to the one or more virtual resources having available timeslots for the class of service of the workflow, selecting a starting timeslot and scheduling the workflow on a selected one or more of the one or more virtual resources, accepting the workflow, and sending one or more local demands corresponding to the workflow to one or more local resource managers managing the selected one or more of the one or more virtual resources.

### CROSS-REFERENCE TO RELATED APPLICATION

This application claims the benefit of U.S. Provisional Patent Application No. 63/372,345, filed Mar. 5, 2022, which is incorporated by reference herein in its entirety.

### FIELD OF THE DISCLOSURE

This disclosure relates generally to scheduling in computing and communications systems, and more particularly, to scheduling of multi-class distributed workflows in computing and communications systems.

### BACKGROUND

Cyber-physical Systems (CPS) are at the core of computing solutions for automotive and transportation, manufacturing, energy, robotics, heath care, and other industries. CPS are deployed at the critical interface between the physical world and the cyber world (e.g., the information technology (IT) world, the Internet, and the world wide web (WWW)). The development of CPS includes addressing challenges in at least two areas: 1) the development and scaling of deterministic, secure, and safe applications; and 2) the deterministic, distributed execution of such applications (e.g., by distributed, deterministic operating system (OS) software (SW)). Both these areas have a fundamental relevance in the development of computing and communications systems and solutions in the areas of technology mentioned above. Currently, these developments are lengthy and costly due to the real-time, security, and safety requirements these infrastructures and solutions need to satisfy. The complexity and cost in developing CPS systems is limiting the scaling and deployment of CPS-based solutions. Successfully addressing these challenges will enable the expansion of the CPS market.

### BRIEF DESCRIPTION OF THE DRAWINGS

FIG. 1 illustrates a computing system in an implementation.

FIG. 2 illustrates a reference distributed system architecture (RDSA) according to an implementation.

FIG. 3 illustrates synchronization and alignment of computing cores and communications virtual links with timeslots according to an implementation.

FIG. 4 illustrates overlaying of Time-Sensitive Networking (TSN)/fifth generation (5G) networking and virtual processing resources according to an implementation.

FIG. 5 illustrates synchronization and alignment of computing virtual cores and communications virtual links timeslots in an implementation.

FIG. 6 illustrates timeslot-based (temporal) partitioning of workflows in an implementation.

FIG. 7 illustrates virtual (spatial) partitioning of computing and communications resources in an implementation.

FIG. 8 illustrates a first example of workflows in an implementation.

FIG. 9 illustrates a second example of workflows in an implementation.

FIG. 10 illustrates a distributed deterministic scheduling architecture (DDSA) according to an implementation.

FIG. 11 illustrates another DDSA according to an implementation.

FIG. 12 illustrates global distributed deterministic resource manager and scheduler (DDRMS) processing according to an implementation.

FIG. 13 illustrates local DDRMS processing according to an implementation.

FIG. 14 is a block diagram of an example processor platform structured to execute and/or instantiate the machine-readable instructions and/or operations of FIGS. 1-13 to implement the apparatus discussed with reference to FIGS. 1-13.

FIG. 15 is a block diagram of an example implementation of the processor circuitry of FIG. 14.

FIG. 16 is a block diagram of another example implementation of the processor circuitry of FIG. 14.

FIG. 17 is a block diagram illustrating an example software distribution platform to distribute software such as the example machine readable instructions and/or operations of FIGS. 1-13 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein includes a distributed, deterministic scheduling architecture (DDSA) and associated distributed deterministic resource manager and scheduler (DDRMS). The DDSA described herein relies on time synchronization across all the distributed resources, and, in particular, across both computing devices and communications devices (e.g., using Institute of Electrical and Electronics Engineers (IEEE) Time-Sensitive Networking (TSN/5G) Standards 802 “IEEE Standard for Local and Metropolitan Area Networks—Timing and Synchronization for Time-Sensitive Applications,” 19 06 2020, and/or Time Coordinated Computing (TCC) available from Intel Corporation, or other suitable time synchronization technology), enabling the alignment of time slots across both computing devices and communications devices. The technology described herein supports definition of multi-class distributed workflows. The technology described herein introduces deterministic Time-Triggered (TT) workflows that place demands onto both computing devices and communications devices based on explicit timeslot (optionally periodic) patterns. The technology described herein provides for the coordinated management of both distributed computing devices and communications devices. The DDSA described herein manages deterministic distributed workflows, which also has the advantage of simplifying the scheduling burden in the networking layer (e.g., TSN/5G capable communications devices), while providing a powerful and scalable admission control phase, combined with efficient distributed per timeslot compute scheduling not relying on preemption.

The proposed approach described herein provides at least several advantages. First, bringing complex real-time computing and/or communications systems to market is a very lengthy, complex and costly process, described by what is known as the V-Process or the V-Model. The technology described herein may be used to simplify and accelerate the V-Process for development of systems and products in the computing and communications industries. The impact of addressing the requirements of determinism on both a computing system and at a distributed level should enable the acceleration of the introduction of CPS platforms and solutions to the market with more cost-competitive alternatives and a much wider ecosystem of suppliers for CPS end-users and system integrators. Second, real-time operating system (RTOS) concepts and systems are extended from discrete local implementations to distributed alternatives. Third, there is an opportunity to close the current gap between software/hardware (SW/HW) computing systems and SW/HW communications systems and their co-operating functions between the two types of systems. Finally, the technology described herein may lead to further optimizations that may be achieved by the fusion of scheduling and data management functionality into hardware (e.g., similar to the optimizations achieved in virtualization through hardware-based implementations of hypervisor functions (e.g., extended page tables (EPT), Intel® virtualization technology (VT-X), etc.)).

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor circuitry” or “hardware resources” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, a computing system (also called a computing device, compute device or a computing resource) can be, for example, a server, a disaggregated server, a personal computer, a workstation, a self-learning machine (e.g., a neural network), a mobile device (e.g., a cell phone, a smart phone, a tablet (such as an iPad′)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of device to perform computing tasks. A computing system may include one or more dynamic random-access memories (DRAMs) to store data.

As used herein, a communications system (also called a communications device or communications resource) can be, for example, a network switch, a router, a network interface card (NIC), or any other type of networking system, device or resource.

As used herein, components of computing systems and/or communications systems of a computing system environment include central processing units (CPUs), graphics processing units (GPUs), field programmable gate arrays (FPGAs), application specific integrated circuits (ASICs), digital signal processors (DSPs), IP blocks, communications circuitry, networking circuitry, computational storage devices, storage and memory devices (including solid state drives (SSDs), dual inline memory modules (DIMMs), etc., HW accelerators (including inference accelerators), XPUs, performance monitoring units (PMUs), or other computing and/or communications devices supporting performance of communications workloads.

In developing computing systems and/or communications systems, one goal is to apply the intelligence (e.g., human intelligence and artificial intelligence (AI) from data, AI, digital twins, etc.) available in the cyber world to achieve a better control of physical systems in many critical vertical industries, such as automotive and transportation, manufacturing, energy, robotics, health care, aerospace and defense, among others. Cyber-physical solutions (CPS) in vertical domains such as these are characterized by the presence of many interconnected computing systems and/or communications systems, hosting data sharing applications of different criticality (e.g., class of service).

An illustrative example is provided by the automotive use case, where multiple computing systems inside each vehicle (hosting multiple control, communications and entertainment applications), is interconnected and cooperates with other distributed applications and services hosted by computing systems in other vehicles, at the public infrastructure edge, and in the cloud.

Some of these applications (e.g., industrial control systems including a controller) need to control physical systems (e.g., through actuators) based on deterministic cycle times. Digital control of this type is based on repeated, periodic cycles over which a controller computes the next command, communicates the command on a communication link (e.g., a field bus), a input/output (I/O) module interfacing with the controlled physical system computes an acknowledgement or a response message, and communicates the response back to the controller.

The process of developing computing systems and/or communications systems of this type is described by the well-known V-Process. For critical computing systems or deterministic CPS systems, the V-Process life-cycle is significantly more complex, involving significant development times and cost, particularly when facing stringent real-time, security, and safety requirements. The integration complexity in the V-Process is a key factor in this, due to unpredictability in software execution, software development practices, and interoperability issues resulting from software or protocol connectivity fragmentation. Today, these CPS deterministic and integration challenges result in costly, lengthy time-to-market, and fixed, proprietary platform products. For example, manufacturers typically hire Systems Integrators (SIs) to design, assemble, and commission industrial control systems based on these closed, fixed-function platforms. Today's SI companies rely on heuristics derived from their own experience to design and integrate an industrial control system. For each subsystem or platform of the industrial control system, there may be dozens of design choices, each offered by a different vendor and each with its own defining characteristics such as cost, power consumption, computational capacity, reliability, etc. Thus, the integration complexity is compounded on a given computing system level largely due to the deterministic, safety, and regulatory requirements that must be met manually, heuristically, and incrementally.

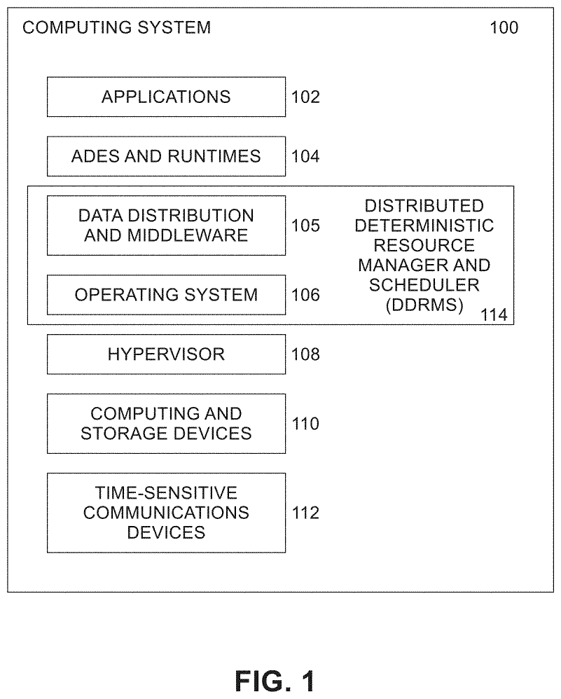

CPS design and development challenges are further exacerbated by a complex and fragmented software stack. FIG. 1 illustrates a computing system 100 in an implementation. Computing system 100 executes one or more applications 102, optionally in conjunction with application development environments (ADEs) and runtimes 104. Data distribution and middleware 105, operating system (OS) 106, and hypervisor 108 software provide well-known capabilities. In an implementation, OS 106 is a real-time OS (RTOS).

The technology described herein includes distributed deterministic resource manager and scheduler (DDRMS) 114. In an implementation. DDRMS 114 may include a RTOS layer (such as operating system (OS) 106) and a data distribution and middleware layer 105. First, RTOSs are required to execute real-time applications 102 while satisfying execution deadlines. Existing RTOSs are limited to being executed by a single processor node and, sometimes, to a single processing core. There is not yet a distributed RTOS and/or a RTOS specified to work based on a Time-Triggered Architecture (TTA) (such as is described in H. Kopetz and G. Bauer, “The Time-Triggered Architecture,” Proceedings of the IEEE, vol. 91, no. 1, pp. 112-126, 01 2003), which is based on system synchronization and timeslots. A popular scheduler is the Rate Monotonic Scheduler developed by Lui Sha (as described in L. Sha, R. Rajkumar and S. Sathaye, “Generalized Rate-Monotonic Scheduling Theory: A Framework for Developing Real-Time Systems,” Proceedings of the IEEE, vol. 82, no. 1, pp. 68-82, 1994), which is provably capable of respecting deadlines when the submitted load is below approximately 66% of the processor capacity. This scheduler, however, heavily relies on preemption, which has negative effects on cache efficiency.

Furthermore, existing RTOSs only manage isolated computing systems and are decoupled from the management of communications systems. In order to handle the need for data distribution across computing systems and interacting applications, there is a need for the functionality in the next layer of the CPS stack. This is the middleware functionality which delivers data distribution services across distributed applications. Technologies such as hypertext transport protocol (HTTP), Client Server, Open Platform Communications Unified Architecture (OPC UA), MQ Telemetry Transport (MQTT), Data Distribution Service (DDS), Zinoh and CoAP, and others belong to this layer. These technologies have not been designed to satisfy the real-time, deterministic, and safe requirements typical of CPS systems. Only recently systems integrators have been trying to interface to and leverage TSN and 5G real-time networking standards. These technologies only deal with data distribution relevant resources, namely, a communications network. There is no coordination with the time sensitive management of computing resources. The lack of coordination across computing and communications systems is one of the fundamental weaknesses in the current real-time stack used in CPS systems.

There is a need for novel technologies that address the complexity, cost, and time involved in the development of CPS solutions. In particular, there is a need for a DDRMS 114 for managing computing and communications resources simultaneously and in coordination. In an implementation, DDRMS 114 works with a Time-Triggered Architecture in contiguous or cooperative management of both computing and communications resources. DDRMS 114 simplifies and automates the development lifecycle at the bottom of the V-process by introducing a novel Distributed, Deterministic Resource Management (DDRM) approach addressing many of the CPS development challenges.

The technology described herein limits DDRMS management to the allocation and scheduling of computing and communications resources distributed across a CPS system. A natural extension of implementations described herein may also encompass memory and I/O resources. DDRMS 114 simplifies the allocation of distributed computing and communications resources from computing and storage devices 110 (managed by hypervisor 108) and/or time-sensitive communications devices 112 to applications 102 (running in application development environments (ADEs) and runtimes 104) that need to perform their tasks deterministically, that is, with absolute guarantees that they can complete all their computing task executions and message communications within deterministic time bounds, even in the worst case.

In an implementation, DDRMS 114 consolidates data distribution and middleware 105 and OS 106 functionality into a unified distributed, deterministic RTOS. Although shown as a separate component in the software stack of computing system 100, in various implementations DDRMS 114 may be implemented in any one or more of data distribution and middleware 105, operating system (OS) 106, hypervisor 108, or in software, firmware and/or hardware in computing and storage devices 110 and/or time-sensitive communications devices 112.

The core infrastructure requirements introduced by CPS include the distribution of computation and communications resources (e.g., a “System of Systems”) and the determinism in the behavior of such systems that need to guarantee predicable, safe and secure service delivery. Such requirements cannot be delivered by existing IT computing solutions, while deterministic systems are usually embedded single node solutions. Thus, DDRMS 114 introduces a novel distributed, deterministic co-scheduling process built on the basis of TTA principles and leveraging TTA technologies. In an implementation, the TTA may be IEEE Time Sensitive Networking (TSN). In another implementation, the TTA may be Intel Time Coordinated Computing (TCC). In other implementations, other TTA technologies may be used.

The technology described herein includes: 1) a Reference Distributed System Architecture (RDSA); 2) a Time-Triggered Architecture (TTA); 3) a Resource Model (RM), including a virtual computing and unidirectional virtual link resource model over aligned timeslots; 4) a Demand Model (DM), including a novel workflow definition having computing associations with one or more workloads and communications associations with flows or network flows (these end-to-end workflows have associated demand characteristics including classes of service and worst-case execution parameters); and 5) a Distributed and Deterministic Scheduling Architecture (DDSA) that enables, based on the TTA, dynamic scheduling of a distributed system set of computing and communications resources and workflows.

Reference Distributed System Architecture (RDSA).

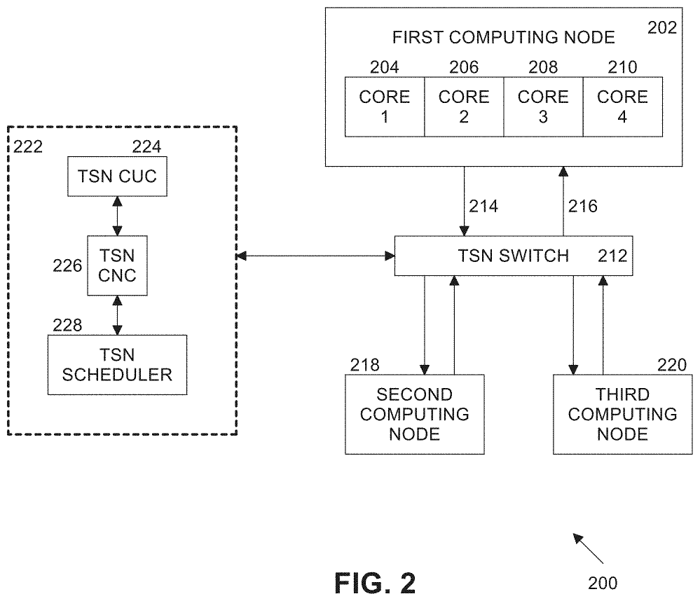

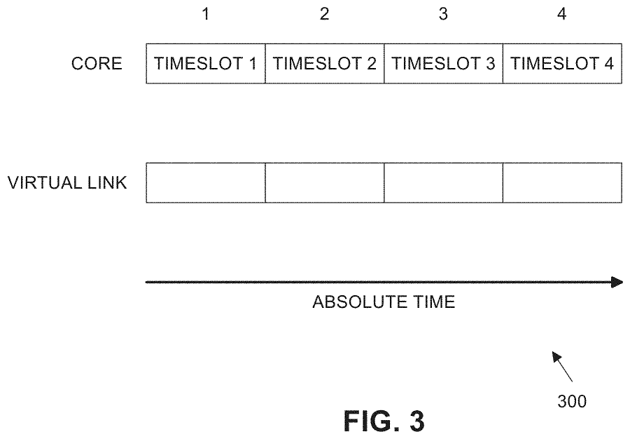

FIG. 2 illustrates a reference distributed system architecture 200 according to an implementation. RDSA 200 may be used to describe a distributed, deterministic, co-scheduling of computing and communications resources. RDSA 200 includes, for example, three computing nodes shown as first computing node 202, second computing node 218, and third computing node 220. In other examples, any other number of computing nodes may be used. In this simple example, first computing node 202 includes core 1 204, core 2 206, core 3 208 and core 4 210. The computing nodes may be connected by Ethernet physical links, supporting IEEE TSN, with a single TSN capable Ethernet switch, TSN switch 212 as a communications device. For example, first computing node 202 is connected by Ethernet physical links 214 and 216 to TSN switch 212. In another implementation, one or more of the physical links may be replaced by 5G or similar wireless links. In an implementation, cores 204, 206, 208, 210 in RDSA 200 support a time coordinating technology such as Intel® Time Coordinated Computing (TCC), which enables the synchronization and alignment of computing and communications timeslots 300 as shown in FIG. 3. Note that any suitable technology bringing timing synchronization into the processing cores and communications devices may be used in other implementations. RDSA 200 includes TSN resource management 222 via TSN centralized user configuration (CUC) 224, TSN centralized network configuration (CNC) 226 and TSN Scheduler 228. In another implementation, RDSA 200 may use a Time-Triggered or time slotted networking technology, such as Profinet RT, Power Link, universal serial bus (USB) with real-time support, or similar technologies. In yet another implementation, cellular technologies providing timing synchronization (such as 5G) may also be used. Implementations described herein rely on the awareness of absolute time across computing and communications resources, enabling the alignment of system timeslots. However, some of the concepts described herein are applicable, with appropriate limitations, in systems supporting traditional field buses and with processing cores not supporting Intel® TCC.

Time-Triggered Architecture (TTA).

RDSA 200 uses principles of a TTA. Under TTA, there is an assumption that an approximate global time base is available to all resource managers (DDRMSs) for computing and communications resources across the distributed system (also referred as “sparse time”). A DDRMS is to monitor and provide organized accounting of resources and their effective utilization and capacity across one or more time slots to support resource allocation, scheduling or admission control. In one example, the distribution of this global time has been standardized by the IEEE 1588 Standard “IEEE Standard for a Precision Clock Synchronization Protocol for Networked Measurement and Control Systems,” 22 09 2016. Events in the system can be ordered in time, deterministically. The TTA builds on the following concepts: 1) A computing and communication interface provides a data sharing boundary between two communicating subsystems that contains temporally accurate state observations; 2) A communications subsystem transports real-time data from an output interface to an input interface within a given time; and 3) a host computer subsystem (e.g., processor) read inputs from an input interface, performs data transformation, and writes output data into an output interface within a given time.

IEEE TSN has built further on these principles to provide a broad set of standards defining the behavior of deterministic Ethernet, called Time Sensitive Networking (TSN). On the wireless side, 5G has adopted many of the TSN principles and is aligned and interworking with TSN. A complement to TSN/5G, with the goal of fully manifesting the TTA, has been introduced by Intel with its Time Coordinated Computing (TCC). TCC is a set of features that augments the compute performance of Intel Corporation processors to address the stringent temporal requirements of real-time applications. TCC reduces jitter and improves performance for latency sensitive applications by extending the availability of approximate global time into the processor.

From the perspective of TTA, TSN/5G, and TCC distributed systems, RDSA 200 manages time through a sequence of aligned timeslots. Every resource manager (e.g., DDRMS 114) is aware of the beginning and end of each timeslot and knows in which timeslot the resource management point is operating. Coordination across distributed computing and/or communications resources thus becomes possible. Furthermore, RDSA 200 manages time consistently from timeslot to timeslot, where performance of computing tasks and communications tasks can be seen as “happening instantaneously” as long as they are completed before the end of each timeslot. This is similar to the behavior of a Synchronous Reactive System (e.g., as described in A. Benveniste and G. Berry, “The Synchronous Approach to Reactive and Real-Time Systems,” Proceedings of the IEEE, vol. 79, no. 9, pp. 1270-1282, 09 1991). This perspective opens the path to CPS simplifications and may significantly ease the validation and certification effort of distributed and deterministic CPSs built on the basis of the technology innovations described herein.

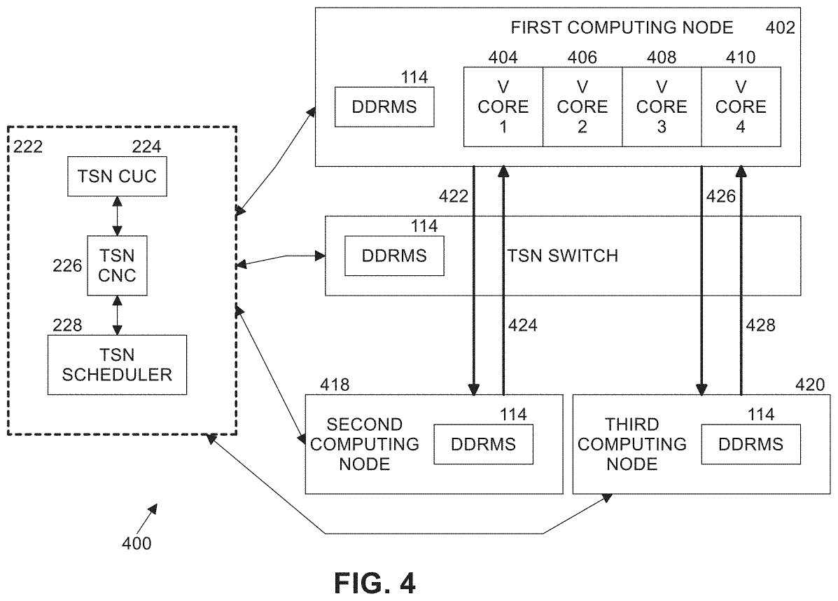

In an implementation, the scheduling approach leverages in a transparent and simple way the TSN/5G infrastructure of RDSA 200. FIG. 4 illustrates overlaying of Time-Sensitive Networking (TSN)/5G and virtual processing resources according to an implementation. Virtual processing resources includes a plurality of virtual cores V core 1 404, V core 2 406, V core 3 408, and V core 4 410 over timeslots, in first computing node 402 in this example. As used herein, a computing node may be an instance of a computing system. With reference to FIG. 4, one of the functions performed by DDRMS 114 is to submit requests to the TSN CUC 224 for the establishment of a set of unidirectional TSN virtual links between computing nodes, for example. In the example shown, a first unidirectional TSN virtual link 422 couples first computing node 402 and second computing node 418, a second unidirectional TSN virtual link 424 couples second computing node 418 and first computing node 402, a third unidirectional TSN virtual link 426 couples first computing node 402 and third computing node 420, and a fourth unidirectional TSN virtual link 428 couples third computing node 420 and first computing node 402. These virtual links provision deterministic flows of Ethernet frames between computing nodes hosting interacting applications of mixed criticality that are generating demands on the computing and communications resources of the underlying distributed system. In a similar way, 5G deterministic virtual links may be provisioned as replacements for or complements to wired TSN links. These virtual links offer a deterministic flow of frames of given bandwidth that will be loaded with messages (from multiple applications) going between the computing nodes they are interconnecting. These TSN/5G virtual links build a deterministic overlay interconnecting the computing nodes in the distributed system and may be designed to support multiple interconnection topologies (e.g., full- or partial-mesh, tree, ring, multicasting, etc.).

In FIG. 4, the simplest interconnection topology is shown which consists of four unidirectional links 422, 424, 426, and 428, configured with their respective bandwidths over timeslots, and characterized by their relevant performance metric (e.g., max latency, jitter, etc.). The proposed approach provides a clean interplay with TSN/5G and enables the new scheduling architecture described herein to delegate the more granular management of the communications resources to TSN scheduler 228. Note however that the requests to TSN/5G are for Node-to-Node links and not Application-to-Application links. This is a fundamental simplification from the perspective of TSN scheduling effort. A static TSN/5G virtual link underlay is assumed. However, the scheduling approach described herein may support dynamic allocations of TSN/5G virtual links to reach a more efficient use of the distributed system resources. For example, the scheduling approach described herein may be extended to the case when a TSN/5G virtual link has a finite lifetime or is intermittent. This is typical of mobile or wireless applications, such as some transportation applications.

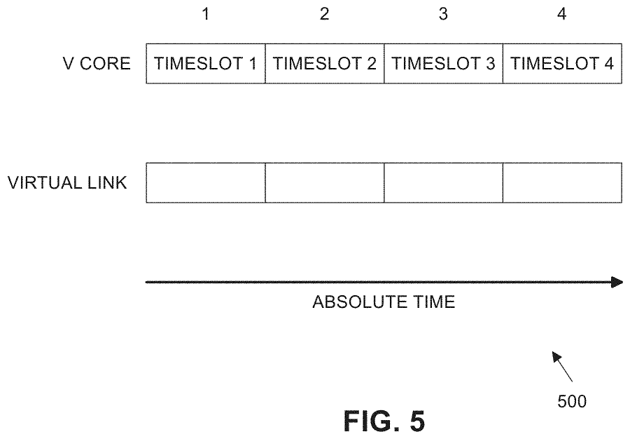

In an implementation, virtual cores 404, 406, 408, 410 in distributed system 400 support a time coordinating technology such as Intel® Time Coordinated Computing (TCC), which enables the synchronization and alignment of computing and communications timeslots 500 as shown in FIG. 5. Note that any technology bringing timing synchronization into the virtual cores may be used in other implementations.

Resource Model.

The distributed system architecture described herein includes a plurality of physical computing and communications resources enabling the support of distributed applications including computing, internal bus bandwidth, cache, main memory, storage, networking bandwidth, etc. Distributed systems are often based on critical computing requirements associated with many CPS systems, where deterministic time, fault-tolerant behavior, safety, and security requirements are significantly more stringent than what is typically seen in cloud or enterprise distributed systems. These requirements are typically associated with environments where operational issues may lead to catastrophic human harm/death, production, or environmental impact. In the technology disclosed herein, the focus is limited to the coordinated allocation of processor computing cycles on each available core and on the communication bandwidth available on the provisioned, deterministic, TSN/5G virtual links set up by requests from DDRMS 114. Extensions to this approach may encompass other resources, such as memory and I/O links.

The resources may be generalized to a set of resources, 1 . . . R, of many types 1 . . . T, with workflows of many classes, 1 . . . C.

The fundamental assumption is that all resource managers are synchronized, i.e., they know with sufficient precision the absolute time, and they agree that time moves through times slots of a given size.

In the aligned time-triggered environment described herein, the resources to be allocated to the demands submitted to the distributed system are described as follows.
N(i) is Computing Node i, belonging to the set of Nodes N;
VL (i, j) is the Virtual Link between Node i and Node j, belonging to the set VL;
CP (i, j, tsₙ) is the processing capacity at Node i and Core j, during timeslot n, belonging to the set CP;
CL (i, j, tsₙ) is the virtual link capacity/bandwidth on Virtual Link between Nodes i and j, during timeslot n, belonging to the set CL.

The resources available on the distributed systems are the set of resources CR=(CP, CL)={CP (i, j, tsₙ), CL (i, j, tsₙ)} over the range of all the corresponding indices. To simplify this exposition, assume that the resources are not timeslot dependent, although the scheduling approach described herein can handle the case of timeslot dependent resources which are more typical in the wireless and mobile environment. The resource management objectives must be managed dynamically or scheduled optimally to meet both local and global resource utilization expectations as well as end-to-end responsiveness. The resource capacities and utilization threshold expectations for all resources are known or defined a priori, and the workflows for end-to-end responsiveness or determinism follow the demand model.

Demand Model—Workflows.

In an implementation, demands submitted to the distributed systems are known as workflows. The necessity of such a concept of workflows, while used in other operational research domains, is a new demand concept for distributed computing, as both communications and computing have approached both scheduling and resource management solutions independently. Thus, in an implementation, workflows are managed via the time-triggered based, distributed, and deterministic scheduling solution. Workflows generate demands on one or more of the computing and communications resources of the distributed system. The demands may or may not be associated to specific system timeslots. As used herein, there are three broad classes of workflows.

Time-Triggered (TT) Workflows.

Demands for TT Workflows are defined on the basis of worst-case execution times (WCETs) and worst-case communication times (WCCTs) on specific resources (processors, virtual links) and with defined temporal patterns over timeslots. The execution of demands associated with timeslots are to be executed/communicated completely by the end of those timeslots (that is, the deadline). Note that demands that are longer than a time slot can also be supported. An example formal definition of a TT Workflow W_TT(i) may include several terms. Demands are defined by a worst-case demand vector (WC (i)), which identifies the worst-case demand for each resource, and the associated sequence of timeslots where the demands need to be satisfied. In an example, WC(i)={{WC (i, j)}, TS (i), OFF (i)}, where WC (i, j) is the worst-case demand for workflow i at resource j, noting that WC (i, j) may be a WCET or a WCCT depending on the resource type. TS (i) is the sequence of time slots with corresponding resources where the workflow demands are processed. OFF (i) is the offset from reference timeslot 0 where TS (i) starts, measured in timeslots. Note that the worst-case demands are assumed to be not timeslot dependent. This assumption may be relaxed, with natural application of the scheduling approach disclosed herein.

Rate Controlled (RC) Workflows.

Demands for RC Workflows are associated with specific resources and to resource rates, which are defined as average rates computed over a number of timeslots or as a moving average over a number of timeslots. An example formal definition of an RC Workflow W_RC (i) may include demands defined by the rate demand vector (WR (i)), which needs to identify the rate demand for each resource and timeslot averaging parameter. WR (i)={{R (i, j)}, Avg (i)}}), TS(i)}}, where TS(i) is the sequence of time slots with corresponding resource where the workflow demands land.

Best Effort (BE) Workflows.

BE Workflows are associated with specific resources but not to specific timeslots. They do not demand nor are guaranteed any minimum individual service amount. Aggregate per resource allocations (e.g., percentage bounds) may be configured for this class of workflows. An example formal definition of a BE Workflow W_BE (i) may include demands defined by the resource demand vector (WRE (i)), which identifies the rate demand for each resource and timeslot averaging parameter. WRE (i)={{RE (i, j), TS (i)}}, where RE is the set of resources where BE workflow i lands the demands of the BE workflow and TS(i) is the sequence of time slots when those resources are requested.

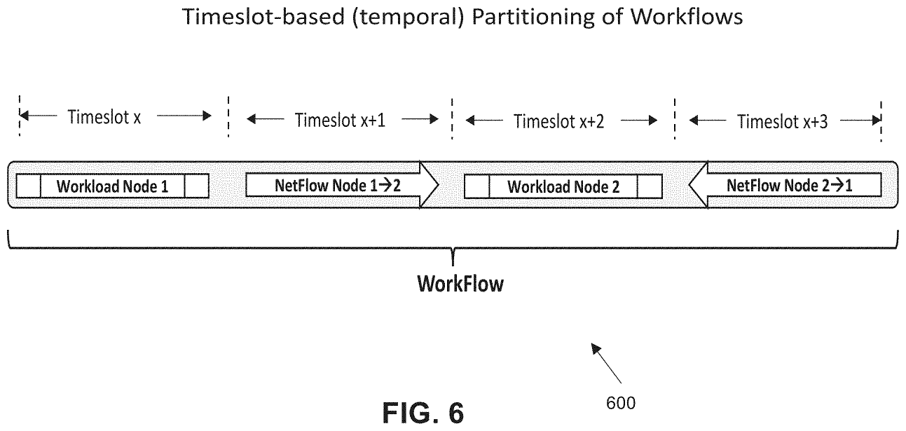

FIG. 6 illustrates timeslot-based (temporal) partitioning 600 of workflows in an implementation. FIG. 6 depicts a new concept of a workflow, taken from the traditional concepts of workloads in computer processing and network flows in communication systems. While existing operating systems and communications systems have implemented scheduling and resource management of workloads and network flows, independently for computing and communications, respectively, no “contiguous” (meaning combining edge-to-edge (E2E) computing-communications) concept exists for managing time-critical workflows across a common time and network-compute resource model using a unified (network-compute) resource management and scheduling system.

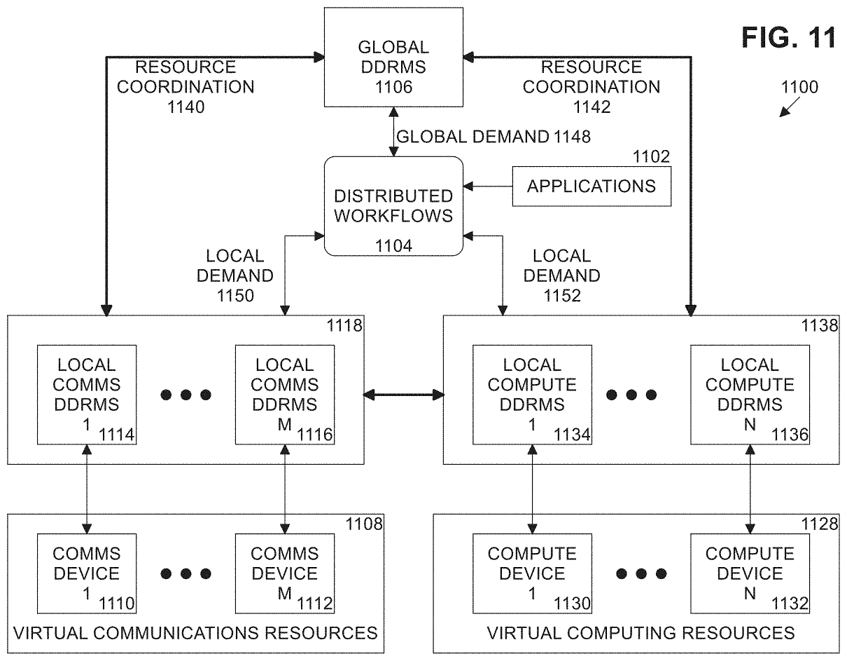

As shown in FIG. 6, a plurality of DDRMS 114 (as instantiated as global DDRMS 1106 and a plurality of local DDRMSs 1114 . . . 1116 and 1134 . . . 1136 of FIG. 11 below) coordinate to ensure each workload (1, 2) and netflow (1→2, 2→1) are assigned or scheduled appropriately to ensure the contiguous (in this example) workflow time-critical processing and communication requirements are met.

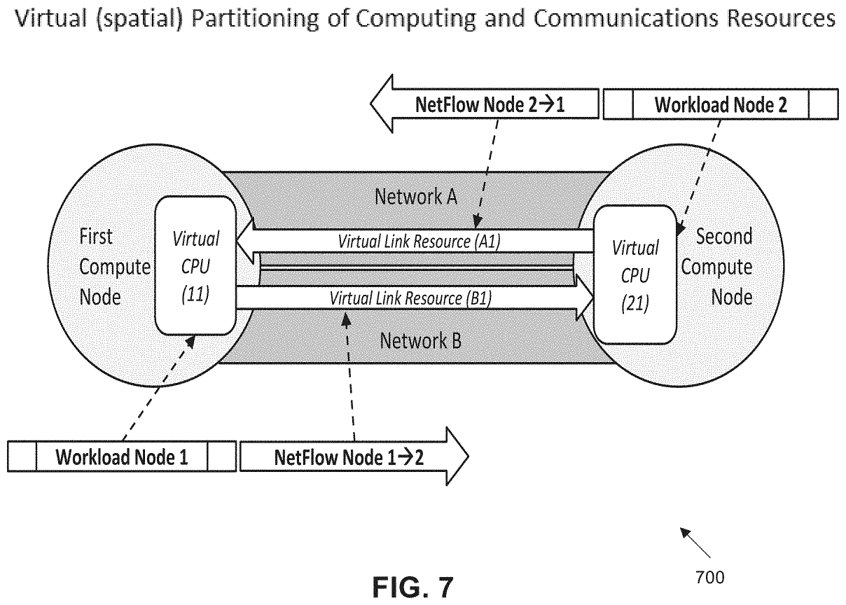

FIG. 7 illustrates virtual (spatial) partitioning 700 of computing and communications resources in an implementation. Likewise, and as shown in FIG. 7, virtualized computing and communications resources are also assigned and scheduled by the plurality of DDRMSs 114 (e.g., global DDRMS 1106 and local DDRMSs 1114 . . . 1116 and 1134 . . . 1136) coordinated to ensure processing and network bandwidth resources are simultaneously accommodated.

Thus, the combined DDRMSs 114 (e.g., global DDRMS 1106 and local DDRMSs 1114 . . . 1116 and 1134 . . . 1136) manage local/global virtual resources and synchronized global timeslots to allocate workflows, perform admission control or schedule workflows across a plurality of system nodes (N) and links (L). It should be noted that workflows may span multiple nodes and multiple network hops and is similarly managed by the DDRMSs 114 (e.g., global DDRMS 1106 and local DDRMSs 1114 . . . 1116 and 1134 . . . 1136) accordingly across multiples of timeslots and virtual resources. For simplicity, FIGS. 6 and 7 depict only four timeslots and four virtual resources, respectively across two nodes and one bidirectional network hop.

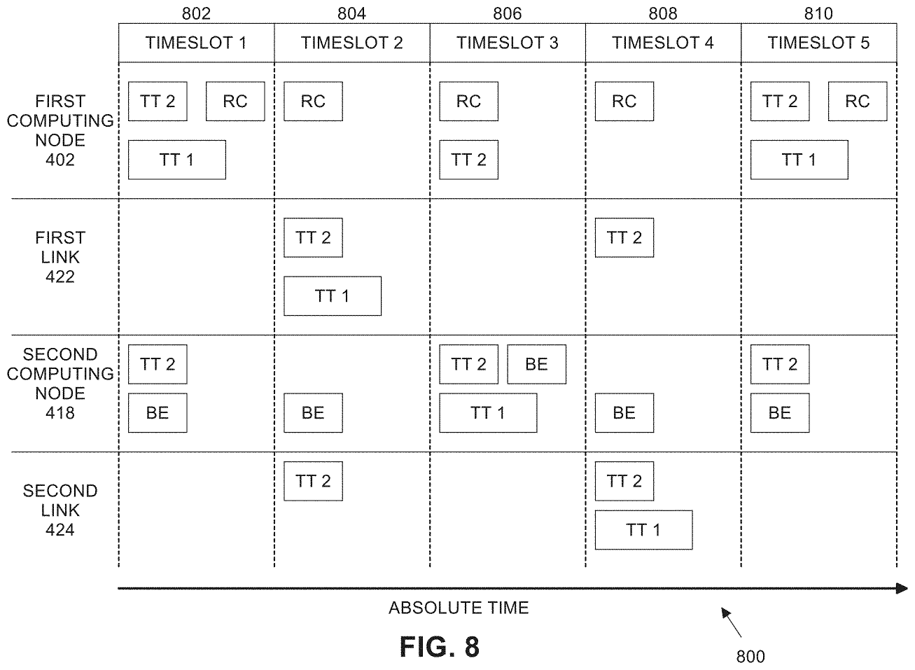

FIG. 8 illustrates a first example 800 of workflows in an implementation. This first example shows a distributed system with two computing nodes 402, 418 connected by two unidirectional links 422, 424 as in FIG. 4, and four example workflows (TT 1, TT 2, RC and BE). The first workflow TT 1 demands worst-case execution or communications times from all four resources 402, 422, 418, 424 in a repeating four timeslot sequence (timeslot 1 802, timeslot 2 804, timeslot 3 806, and timeslot 4 808, which then starts repeating with timeslot 5 810, . . . ). The second workflow TT 2 is also periodic (every other timeslot in this example) and demands performance of simultaneous tasks over the processing cores of the computing nodes 402, 418, and performance of simultaneous message tasks over the virtual links 422, 424 in the succeeding timeslots as shown. For both TT workflows TT 1 and TT 2, the corresponding offsets are set to 0. The RC and BE workflows only demand service from first computing node 402 and second computing node 418, respectively.

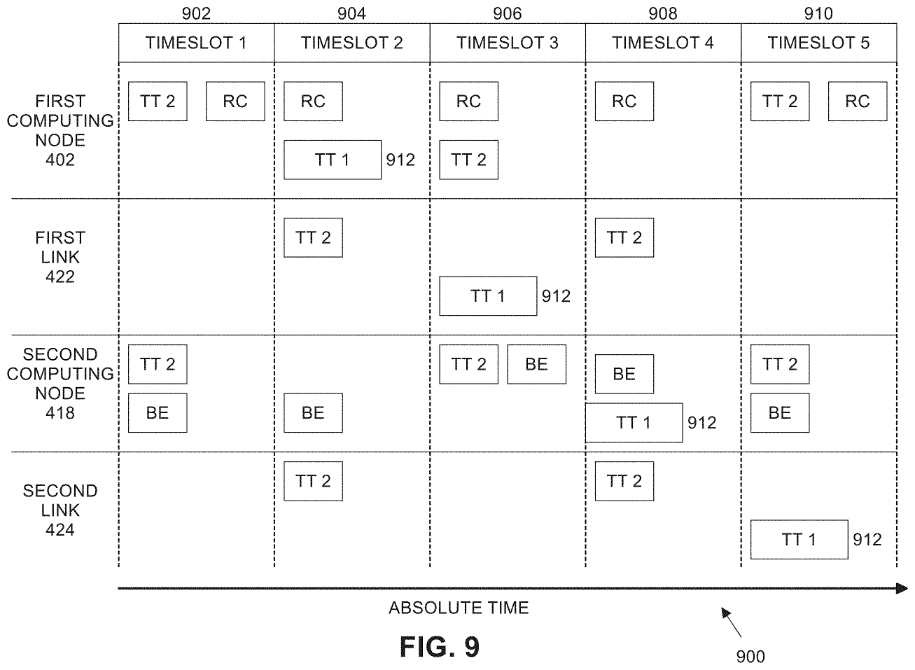

FIG. 9 illustrates a second example 900 of workflows in an implementation. The first workflow TT 1 912 demands worst-case execution or communications times from all four resources 402, 422, 418, 424 in a repeating four timeslot sequence (timeslot 1 902, timeslot 2 904, timeslot 3 906, and timeslot 4 908, which then starts repeating with timeslot 5 910, . . . ). In the second example, workflow TT 1 912 has been offset by one timeslot. In an implementation, a workflow with an offset may be an exceptional workflow. Alternatively, an offset may be the result of the admission control negotiation.

In an implementation, an exceptional asynchronous TT Workflow (XTT) may request immediate service by specific resources and at a predetermined sequence of absolute arrival times, with known worst-case resource demands. In an implementation, the distributed system also supports a TT Interrupt, which may be handled similar to an XTT but with unknown absolute arrival times.

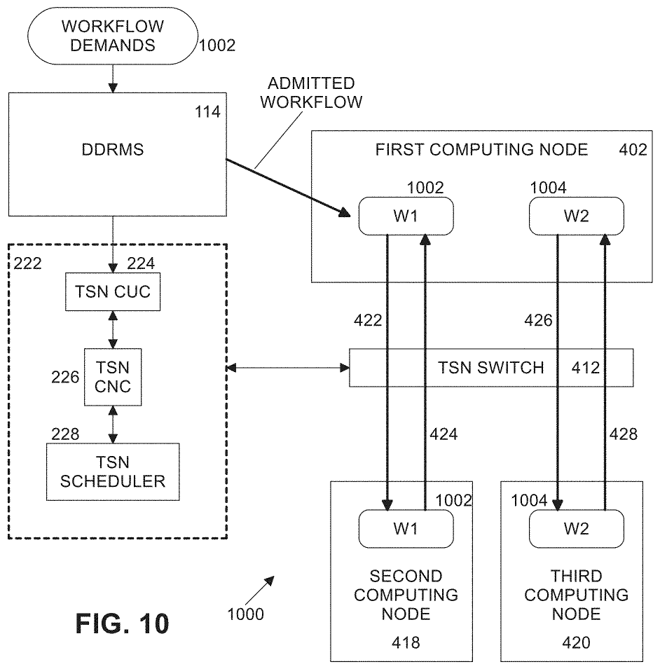

FIG. 10 illustrates a distributed deterministic scheduling architecture (DDSA) 1000 according to an implementation. The aggregate set of demands 1002 submitted by the workflows, either as a batch or incrementally, may be managed by an admission control process implemented by DDRMS 114. DDRMS 114 determines the admissibility (feasibility) of the aggregate workflow demand based on the workflow class of service. For TT feasibility, no timeslot can be overallocated with worst-case deterministic TT demands after periodic load offset negotiation. Handling “overallocation” by TT demands needs to take into account configured aggregate per resource rates set aside for RC workflows and a per resource percentage set aside for BE workflows. This may translate into a per resource and per time slot reserved fixed resource percentage RES_F (i) or a reserved average percentage across timeslots RES_R (i). For RC feasibility, a sufficient aggregate rate, averaged over a number of time slots, needs to be available. For BE feasibility, this is not applicable. An appropriate per resource aggregate percent bounds for BE needs to be reserved.

The admission control test implemented by DDRMS 114 poses an operations research optimization problem that may be addressed by using traditional operations research methods or emerging AI approaches. In an implementation, the admission control test may be a timeslot packing problem, where the time offsets of the TT workflows are the optimization variables. Constraints are imposed by the RC and BE reservations. An example formal description of the proposed admission control problem is outlined herein. For simplicity, only admission control for TT workflows is discussed and workflows of other classes are omitted.

Let S be the set of timeslots under consideration. Let R be the set of resources under consideration, with CR the corresponding set of resource capacities, an assumed constant for this example. Let W_TT be the sets of workflows of the TT class, with WC, TS, and OFF the corresponding sets of worst-case demands, timeslot targets, and offsets for the TT workflows demands, respectively.

The set of workflows W_TT is admissible if the following is true: Min (over i in S and j in R) Max (over OFF {(CR (i, j)−Sum ((over k in W_TT of WC (k, j) which are relevant to timeslot i based on T(k)) and OFF (k))}>=0.

The set of workflows W_TT is admissible if there is a choice of offsets such that for all resources and timeslots, the sum of the worst-case demands does not exceed the corresponding capacity. Straightforward extensions of the above problem statement can address the presence of reservations for RC and BE workflows, either by appropriately reducing the capacity values in the formulation and/or adding appropriate constraints to this formulation. This admissibility test can become cumbersome to execute when the number of workflows, resources, and timeslots increases; however, the execution of this test should be naturally achievable by using well known optimization techniques (e.g., simulated annealing, dynamic programming, etc.). In various implementations, any number of traditional or AI-based optimization approaches may also be used.

Once admitted, workflows become active and offer actual tasks to communications and/or computing resources, as shown in FIG. 10. Workflows W1 1002 and W2 1004 are competing for resources on cores on first computing node 402, second computing node 418, and third computing node 420, and on virtual links 422, 424, 426, 428 between those nodes. When workflows are accepted incrementally, a workflow needs to satisfy the feasibility test before the workflow can be activated.

Per-resource distributed processor and virtual link schedulers within the appropriate DDRMSs perform dynamic scheduling for each timeslot thereby satisfying TT timeslot deadlines, RC rates, and BE aggregate bounds. The schedulers first serve the TT tasks ready to be executed by the end of the previous timeslot. Because of the worst-case-based admission control performed on all TT workflows, all the TT tasks can be executed completely before the end of the current time slot. The TT tasks would typically not require their worst-case demands and would leave ample resources for RC and BE tasks. A feature of the proposed DDSA 1000 is that the DDSA reduces dramatically the frequency of task preemption with respect to existing real-time CPU schedulers. This is due to the fact that the order followed in executing TT tasks during each timeslot is not relevant as long as all the TT tasks are completed before the end of the timeslot. This behavior should lead to much improved cache performance and reduced context switching overheads.

FIG. 11 illustrates another DDSA 1100 according to an implementation. In this implementation, the functionality of DDRMS 114 is instantiated as one global DDRMS 1106 and a plurality of local DDRMSs 1114 . . . 1116, and 1134 . . . 1136. DDSA 1100 include a plurality of virtual communications resources 1108, including a plurality of communications (comms) devices, such as comms device 1 1110 . . . comms device M 1112, where M is a natural number, and a plurality of virtual computing resources 1128, including a plurality of computing (compute) devices, such as compute device 1 1130 . . . compute device N 1132, where N is a natural number.

Each distributed resource (e.g., comms device 1 1110 . . . comms device M 1112 and compute device 1 1130 . . . compute device N 1132) is individually managed by an instance of a local DDRMS 114. For example, local comms DDRMS 1114 manages comms device 1 1110 . . . local comms DDRMS M 1116 manages comms device M 1112, respectively, and local compute DDRMS 1 1134 manages compute device 1 1130 . . . local compute DDRMS N 1136 manages compute device N 1132, respectively. In an implementation, local DDRMSs perform execution of resource management, admission control and scheduling functions applied to the virtual resource being managed. Collectively, local comms DDRMSs are denoted 1118 and local compute DDRMSs are denoted 1138 in FIG. 11.

Global resource management, admission control and scheduling functions for the system of distributed resources embodied as DDSA 1100 are performed by the global DDRMS 1106, which may optionally be redundant, and which communicates resource coordination messages 1140 and 1142 to local comms DDRMSs 1114 and local compute DDRMSs 1138, respectively. Examples of resource coordination messages 1140, 1142 include local resource status updates, and notifications about new workflow admission decisions.

Applications 1102 desiring to be executed by computing and communications resources in DDSA 1100, generate distributed workflows 1104, of various classes of service. In the exemplary case discussed here, the classes of service are Time-Triggered (TT), Rate Control (RC) and Best Effort (BE).

A new workflow is initially represented as a global demand 1148 for service across distributed resources and time slots. Global demand 1148 is received by global DDRMS 1106. The global demand 1148 for the new workflow requesting services (e.g., virtual communications resources 1108 and virtual computing resources 1128) is processed by the global DDRMS 1106, to determine if the new workflow can be accepted, and how and when that workflow can be served by the appropriate distributed virtual resources 1108, 1128. For example, global DDRMS 1106 determines when the new workflow will start service (e.g., via an offset), and which virtual communications resources 1108 and virtual computing resources 1128 will best serve that workflow demand. In an implementation, these decisions may require execution of complex combinatorial optimization operations research processes and may optionally use artificial intelligence (AI) techniques such as machine learning (ML). In other implementations, other alternative approaches may be identified for global DDRMS 1106 functionality.

Once the global DDRMS 1106 has made an admission decision for the new workflow, local demands 1150 and 1152 corresponding to the newly admitted workflow are communicated to the corresponding local comms DDRMSs 1114 . . . 1116 and local compute DDRMSs 1134 . . . 1136, respectively, as needed. Each local comms DDRMS and local computing DDRMS performs local resource management, admission control and scheduling functions based at least in part on the information received about the new local demands to be satisfied. Note that local demands 1150, 1152 request resources delivered within specific timeslots, in competition with other local demands requesting service during the same timeslots. Local scheduling by local DDRMSs collectively determine the order in which all demands for service during a (universal, global) time slot are satisfied across the virtual resources 1108, 1128.

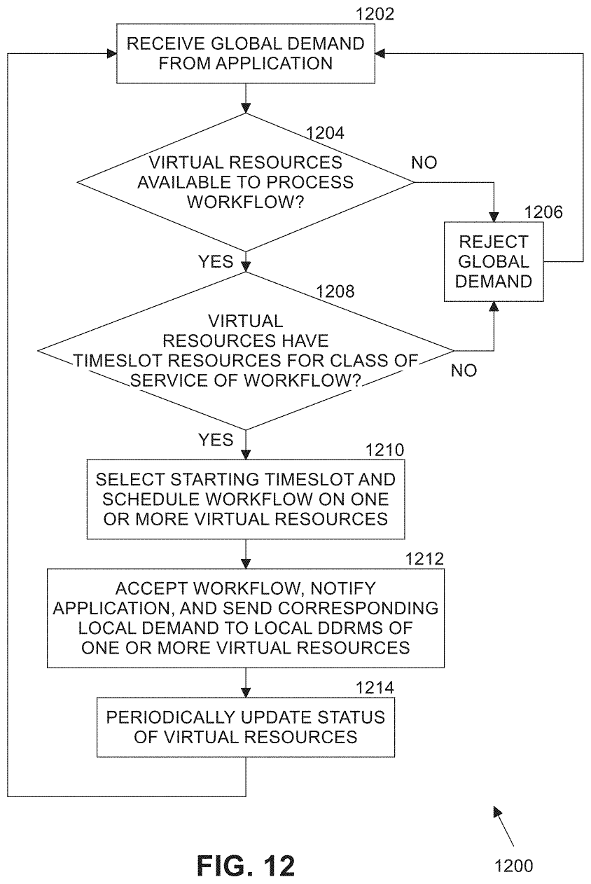

FIG. 12 illustrates global distributed deterministic resource manager and scheduler (DDRMS) processing 1200 according to an implementation. In an implementation, the actions represented in FIG. 12 may be performed by global DDRMS 1106 of DDSA 1100. Applications 1102 generate global demands for workflows based at least in part on class of service (e.g., TT, RC, and BE, etc.). At block 1202, global DDRMS 1106 receives a global demand 1148 for execution of a distributed workflow 1104 from an application 1102. At block 1204, global DDRMS 1106 determines if sufficient virtual resources (e.g., virtual communications resources 1108 and/or virtual computing resources 1128) are available to process the workflow. If not, the global demand 1148 is rejected at block 1206 and processing continues with a next global demand at block 1202. If sufficient virtual resources are available, at block 1208 global DDRMS 1106 determines if the virtual resources have available timeslot resources for the requested class of service for the workflow. In an implementation, there may be multiple possible ways to satisfy a global demand. If not, the global demand 1148 is rejected at block 1206 and processing continues with a next global demand at block 1202. If the virtual resources do have available timeslot resources for the requested class of service for the workflow, at block 1210 global DDRMS 1106 selects a starting timeslot and schedules the workflow on one or more virtual resources. In an implementation, global DDRMS 1106 selects an optimal starting timeslot for execution of the workflow. At block 1212, global DDRMS 1106 accepts the workflow, notifies the application 102 and sends one or more corresponding local demands 1150, 1152, as needed, to local DDRMSs (e.g., local comms DDRMSs 1114 . . . 1116 and local compute DDRMSs 1134 . . . 1136) of the scheduled one or more virtual resources (e.g., virtual communications resources 1108 and/or virtual computing resources 1128). In an implementation, when a workflow is accepted by global DDRMS 1106, the global DDRMS creates an entry for the accepted workflow in a global active workflow table. At block 1214, global DDRMS 1106 periodically updates the status of the virtual resources. Processing of a next global demand may be performed back at block 1202.

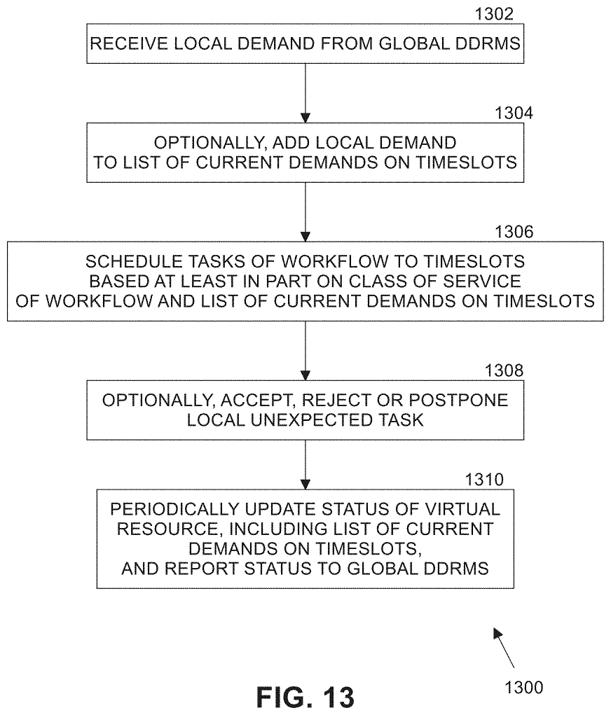

FIG. 13 illustrates local DDRMS processing 1300 according to an implementation. In an implementation, the actions represented in FIG. 13 may be performed by any one or more local DDRMS of DDSA 1100, such as local comms DDRMS 1 1114 . . . local comms DDRMS M 1116 and local compute DDRMS 1 1134 . . . local compute DDRMS N 1136. At block 1302, local DDRMS receives a local demand (e.g., local demand 1150 for one of local comms DDRMSs 1114 . . . 1116 or local demand 1152 for one of local compute DDRMS 1134 . . . 1136) from global DDRMS 1106. At block 1304, the local DDRMS optionally adds the local demand to a list of current demands on timeslots for the virtual resource managed by the local DDRMS. At block 1306, the local DDRMS schedules one or more tasks of the workflow to one or more timeslots based at least in part on the class of service of the workflow (including the tasks) and the list of current demands on timeslots. In various implementations, different processes and/or policies for scheduling tasks of the workflow may be used. For example, in one policy, TT tasks may be scheduled in order from predicted longest time to predicted shortest time, then RC tasks, and then BE tasks. At block 1308, the local DDRMS optionally accepts, rejects or postpones any local unexpected tasks (e.g., interrupts) that may arise (due to for example, exceptional demand entering the system or an existing demand that may be priority elevated based on service level agreement (SLA) changes), based at least in part on information local to the local DDRMS. In an implementation, when a local demand is accepted by the local DDRMS, the local DDRMS creates an entry for the accepted local demand in a local active demand table. At block 1310, the local DDRMS periodically updates the status of the virtual resource managed by the local DDRMS, including the list of current demands on timeslots, and reports the status to global DDRMS 1106.

When a workflow is terminated, global DDRMS 1106 may update the global active workflow table to reflect the termination. In addition, local DDRMSs may update one or more entries in their local active demand tables for local demands associated with the terminated workflow.

DDSA 1100 provides a simplification and unification of computing and communications scheduling of workflows for deterministic and distributed systems, naturally extended to memory and I/O resources, consolidates critical and previously un-coordinated layers of the real-time software stack, and accelerates the V-process for delivery of mission critical, certifiable and verifiable computing systems.

While an example manner of implementing the technology described herein is illustrated in FIGS. 1-13, one or more of the elements, processes, and/or devices illustrated in FIGS. 1-13 may be combined, divided, re-arranged, omitted, eliminated, and/or implemented in any other way. Further, the example computing systems and/or communications systems described with reference to FIGS. 1-13 may be implemented by hardware, software, firmware, and/or any combination of hardware, software, and/or firmware. Thus, for example, any of computing systems and/or communications systems described with reference to FIGS. 1-13 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example circuitry of FIGS. 1-13 may include one or more elements, processes, and/or devices in addition to, or instead of, those illustrated in FIGS. 1-13, and/or may include more than one of any or all the illustrated elements, processes and devices.

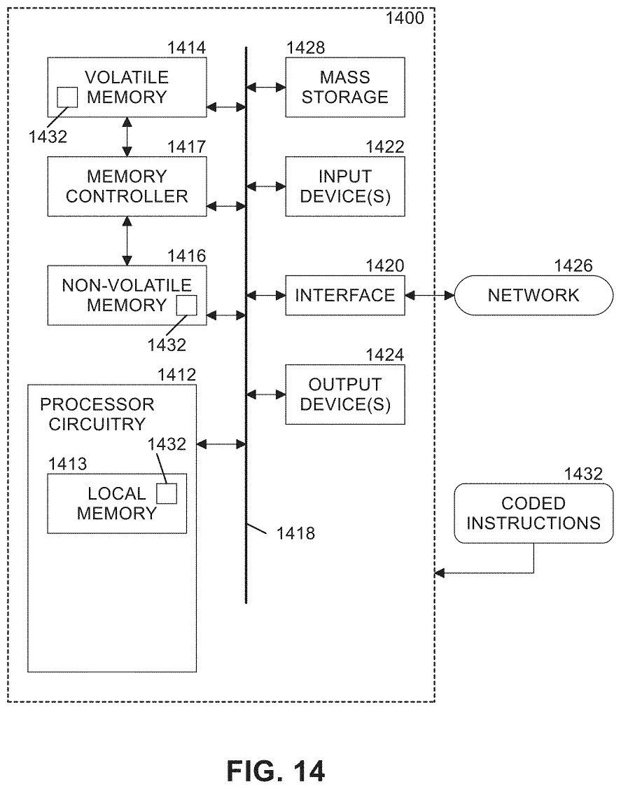

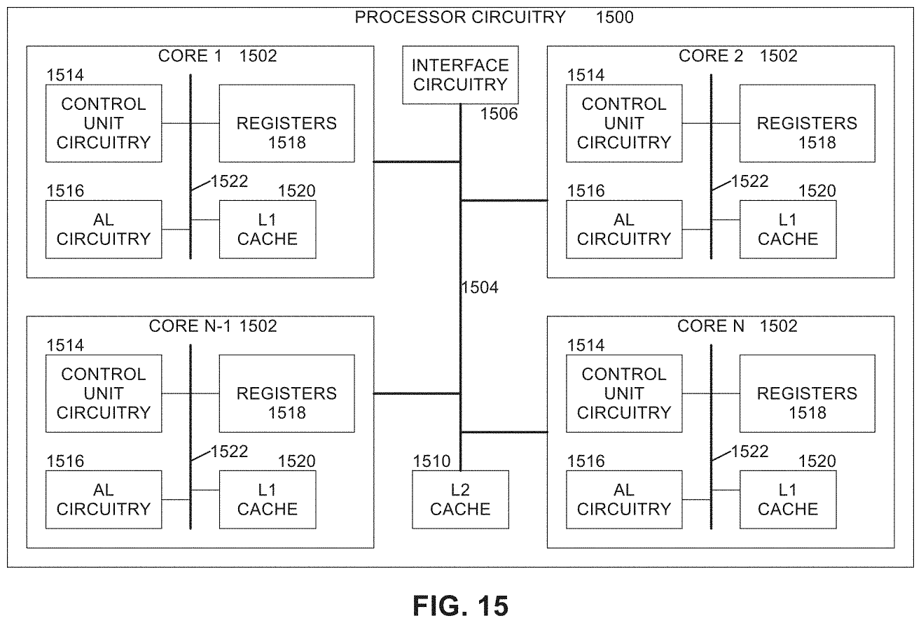

Diagrams representative of example hardware logic circuitry, machine readable instructions, hardware implemented state machines, and/or any combination thereof are shown in FIGS. 1-13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices.

Further, although the example program is described with reference to the diagrams illustrated in FIGS. 1-13, many other methods of implementing the example computing system may alternatively be used. For example, the order of execution of the blocks may be changed, and/or some of the blocks described may be changed, eliminated, or combined. Additionally or alternatively, any or all of the blocks shown in FIGS. 1-13 may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 1-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 14 is a block diagram of an example processor platform 1400 structured to execute and/or instantiate the machine-readable instructions and/or operations described in FIGS. 1-13. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, GPUs, DSPs, and/or microcontrollers from any desired family or manufacturer. The processor circuitry 1412 may be implemented by one or more semiconductor based (e.g., silicon based) devices.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1432, which may be implemented by the machine-readable instructions of FIGS. 1-13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all the machine-readable instructions and/or operations represented by the diagrams of FIGS. 1-13.

The cores 1502 may communicate by an example bus 1504. In some examples, the bus 1504 may implement a communication bus to effectuate communication associated with one(s) of the cores 1502. For example, the bus 1504 may implement at least one of an Inter-Integrated Circuit (I2C) bus, a Serial Peripheral Interface (SPI) bus, a PCI bus, or a PCIe bus. Additionally or alternatively, the bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2) cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache in local memory 1520, and an example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating point operations. In yet other examples, the AL circuitry 1516 may include first AL circuitry that performs integer-based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The bus 1504 may implement at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

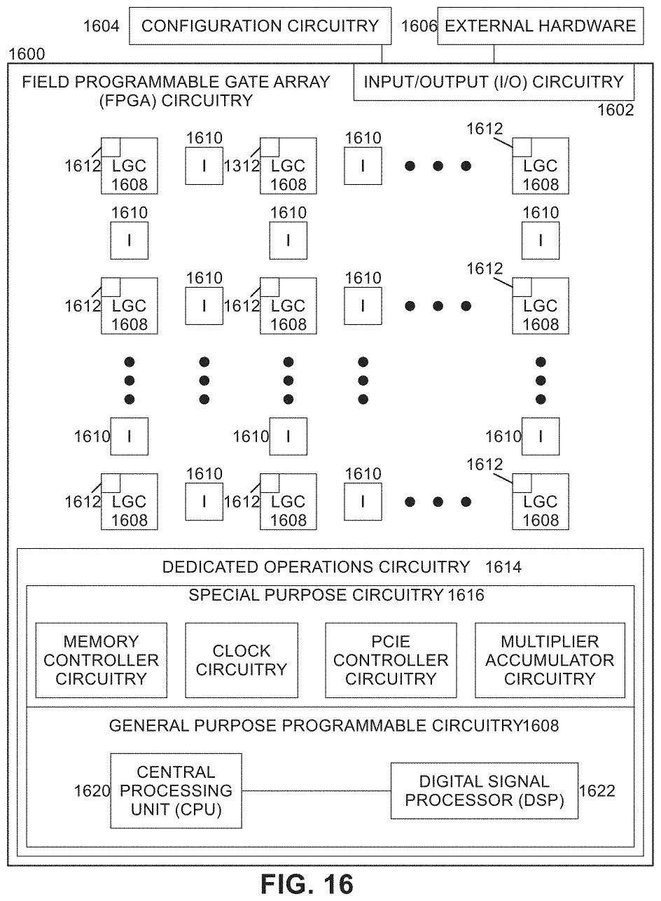

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1400 of FIG. 14 executing corresponding machine-readable instructions. However, once configured, the FPGA circuitry 1600 instantiates the machine-readable instructions in hardware and, thus, can often execute the operations faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the diagrams of FIGS. 1-13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine-readable instructions represented by the diagrams of FIGS. 1-13. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the diagrams of FIGS. 1-13. As such, the FPGA circuitry 1600 may be structured to effectively instantiate some or all the machine-readable instructions of the diagrams of FIGS. 1-13 as dedicated logic circuits to perform the operations corresponding to those software instructions in a dedicated manner analogous to an ASIC. Therefore, the FPGA circuitry 1600 may perform the operations corresponding to the some or all the machine-readable instructions of FIGS. 1-13 faster than the general-purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1400 of FIG. 14. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine-readable instructions of FIGS. 1-13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine-readable instructions represented by the diagrams of FIGS. 1-13 may be executed by one or more of the cores 1502 of FIG. 15 and a second portion of the machine-readable instructions represented by the diagrams of FIGS. 1-13 may be executed by the FPGA circuitry 1600 of FIG. 16.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

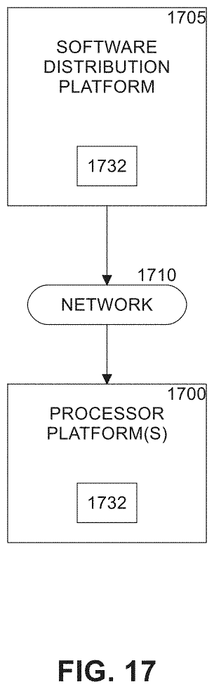

A block diagram illustrating an example software distribution platform 1705 to distribute software such as the example machine readable instructions 1432 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1432, which may correspond to the example machine readable instructions, as described above. The one or more servers of the example software distribution platform 1705 are in communication with a network 1710, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1432 from the software distribution platform 1705. For example, the software, which may correspond to the example machine readable instructions described above, may be downloaded to the example processor platform 1700, which is to execute the machine-readable instructions 1432 to implement the methods described above and associated computing systems and/or communication systems described above. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

In some examples, an apparatus includes means for data processing by computing systems and/or communications systems of FIGS. 1-13. For example, the means for processing may be implemented by processor circuitry, processor circuitry, firmware circuitry, other circuitry, etc. In some examples, the processor circuitry may be implemented by machine executable instructions executed by processor circuitry, which may be implemented by the example processor circuitry 1412 of FIG. 14, the example processor circuitry 1500 of FIG. 15, and/or the example Field Programmable Gate Array (FPGA) circuitry 1600 of FIG. 16. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide a distributed deterministic resource manager and scheduler in a distributed deterministic system architecture in a computing system. The disclosed systems, methods, apparatus, and articles of manufacture improve the efficient operation of a computing device by distributing workflows to be executed by one or more computing systems and/or communications systems. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. A system comprising:
a memory to store a workflow of an application; and
a processor to
receive a global demand to process the workflow;
determine if one or more virtual resources are available to process the workflow;
in response to the one or more virtual resources being available to process the workflow, determine if the one or more virtual resources have available timeslots for a class of service of the workflow; and
in response to the one or more virtual resources having available timeslots for the class of service of the workflow, select a starting timeslot and schedule the workflow on a selected one or more of the one or more virtual resources, accept the workflow, and send one or more local demands corresponding to the workflow to a second processor managing the selected one or more of the one or more virtual resources.

2. The system of claim 1, comprising the processor to reject the global demand in response to no virtual resources being available to process the workflow or no virtual resources having available timeslots for the class of service of the workflow.

3. The system of claim 1, comprising the processor to notify the application of acceptance of the workflow.

4. The system of claim 1, comprising the second processor to receive the one or more local demands; and schedule one or more tasks of the workflow to timeslots based at least in part on the class of service of the workflow and current demands on the timeslots.

5. The system of claim 1, wherein the class of service of the workflow comprises one of time-triggered (TT), rate controlled (RC), and best efforts (BE).

6. The system of claim 4, wherein the one or more virtual resources comprise one or more virtual communications resources and one or more virtual computing resources.

7. The system of claim 6, wherein the one or more virtual communications resources comprise one or more communications devices and the one or more virtual computing resources comprise one or more computing devices.

8. The system of claim 7, wherein the one or more communications devices and the one or more computing devices operate on a same global time and are time synchronized.

9. The system of claim 8, wherein the one or more communications devices and the one or more computing devices perform the one or more tasks according to a time-triggered architecture.

10. The system of claim 7, wherein the one or more tasks are performed by the one or more communications devices and the one or more computing devices deterministically.

11. The system of claim 1, comprising the processor to select the starting timeslot and schedule the workflow according to a time-triggered architecture.

12. The system of claim 1, wherein the processor and the second processor are synchronized.

13. A method comprising:
receiving a global demand to process a workflow;
determining if one or more virtual resources are available to process the workflow;
in response to the one or more virtual resources being available to process the workflow, determining if the one or more virtual resources have available timeslots for a class of service of the workflow; and
in response to the one or more virtual resources having available timeslots for the class of service of the workflow, selecting a starting timeslot and scheduling the workflow on a selected one or more of the one or more virtual resources, accepting the workflow, and sending one or more local demands corresponding to the workflow to one or more local resource managers managing the selected one or more of the one or more virtual resources.

14. The method of claim 13, comprising rejecting the global demand in response to no virtual resources being available to process the workflow or no virtual resources having available timeslots for the class of service of the workflow.

15. The method of claim 13, comprising, by the one or more local resource managers, receiving the one or more local demands; and scheduling one or more tasks of the workflow to timeslots based at least in part on the class of service of the workflow and current demands on the timeslots.

16. The method of claim 13, wherein the class of service of the workflow comprises one of time-triggered (TT), rate controlled (RC), and best efforts (BE).

17. The method of claim 13, wherein the one or more virtual resources comprise one or more communications devices and one or more computing devices.

18. The method of claim 17, wherein the one or more communications devices and the one or more computing devices operate on a same global time and are time synchronized.

19. At least one machine-readable storage medium comprising instructions which, when executed by at least one processor, cause the at least one processor to:
receive a global demand to process a workflow;
determine if one or more virtual resources are available to process the workflow;
in response to the one or more virtual resources being available to process the workflow, determine if the one or more virtual resources have available timeslots for a class of service of the workflow; and
in response to the one or more virtual resources having available timeslots for the class of service of the workflow, select a starting timeslot and schedule the workflow on a selected one or more of the one or more virtual resources, accept the workflow, and send one or more local demands corresponding to the workflow to a second processor managing the selected one or more of the one or more virtual resources.

20. The at least one machine-readable storage medium of claim 19, comprising instructions which, when executed by at least one processor, cause the at least one processor to receive the one or more local demands; and schedule one or more tasks of the workflow to timeslots based at least in part on the class of service of the workflow and current demands on the timeslots.
